(19) United States
(12) Patent Application Publication
(10) Pub. No.: US 2007/0293178 A1
(43) Pub. Date: Dec. 20, 2007

(54) Antenna Control

(76) Inventors: Darin Milton, Campbell, CA (US); William S. Kish, Saratoga, CA (US); Victor Shtrom, Sunnyvale, CA (US)

Correspondence Address: CARR & FERRELL LLP, 2200 GENG ROAD, PALO ALTO, CA, 94303, US

(21) Appl. No.: 11/752,917

(22) Filed: May 23, 2007

Related U.S. Application Data
(60) Provisional application No. 60/808,196, filed on May 23, 2006.

(51) Int. Cl. H04B 7/00

(52) U.S. Cl. 455/269

(57) ABSTRACT

Modulation of a DC voltage to communicate from an antenna controller to a configurable antenna is disclosed. The DC voltage may communicate to both data and power circuits within the configurable antenna. The antenna controller and configurable antenna may be coupled by two electrical conductors over which both the modulated DC voltage and a radio frequency (RF) signal are communicated. By communicating both the RF signal and configuration data over the same two wire conductor, the configuration data can be communicated through a legacy RF connection in the antenna controller.

### CROSS-REFERENCE TO RELATED APPLICATIONS

The present application claims the priority benefit of U.S. provisional patent application No. 60/808,196 filed May 23, 2006 and entitled “Antenna Control Over Radio Frequency Connector,” the disclosure of which is incorporated herein by reference.

The present application is related to U.S. patent application Ser. No. 11/414,117 filed Apr. 28, 2006 and entitled “MultiBand Omnidirectional Planar Antenna Apparatus With Selectable Elements.” The present application is further related to U.S. patent application Ser. No. 11/413,461 filed Apr. 28, 2006 and entitled “Coverage Antenna Apparatus with Selectable Horizontal and Vertical Polarization Elements.” The disclosure of each of the aforementioned applications is incorporated herein by reference.

### BACKGROUND OF THE INVENTION

1. Field of the Invention

The present invention relates generally to controlling configurable antennas. More specifically, the present invention related to communicating RF signal and configuration data over a common conductor such that configuration data can be communicated through a legacy RF connection in an antenna controller.

2. Description of the Related Art

Multiband communication devices for generating and transmitting RF (like those designed by Ruckus Wireless, Inc. of Sunnyvale, Calif.) may include selectable antenna elements, each of which may have its own individual gain and a directional radiation pattern. Legacy antenna controllers may not immediately be compatible with such selectable element antenna designs. As such, there is a need in the art for antenna control of these modern communication devices through a legacy RF connection in an antenna controller.

### SUMMARY OF THE INVENTION

Various embodiments of the invention include modulation of a DC voltage to communicate from an antenna controller to a configurable antenna. The DC voltage is used to both communicate data and to power circuits within the configurable antenna. In some embodiments, the antenna controller and configurable antenna are coupled by two electrical conductors over which both the modulated DC voltage and a radio frequency (RF) signal are communicated. By communicating both the RF signal and configuration data over the same two wire conductor, the configuration data can be communicated through a legacy RF connection in the antenna controller.

The invention may be employed in a wide variety of applications including WiFi (e.g., 802.11 or the like) communications in which digital data is encoded in an RF signal communicated between a base station and one or more clients. A base station may be coupled to a configurable base station antenna by a two wire conductor. Configuration of the base station antenna may allow the energy of an RF signal to be directed in one or more particular directions or for the antenna to be more sensitive to signals from particular directions thereby allowing for greater communication speed, greater communication reliability and/or greater communication range. Alternative applications of the invention may include the communication of audio, television, satellite, and video signals.

### BRIEF DESCRIPTION OF THE DRAWINGS

FIG. 1 is a block diagram illustrating an antenna controller, a connector, and a configurable antenna.

FIG. 2 is a timing diagram illustrating the communication of digital data using a modulated DC signal.

FIG. 3 is a flow diagram illustrating the operation of a state machine.

FIG. 4 is a circuit diagram illustrating an electronic circuit of an antenna controller.

FIG. 5 is a circuit diagram illustrating further details of a circuit configured to generate a DC modulated signal.

FIG. 6 is a circuit diagram illustrating an output circuit of a digitally controllable DC modulator.

FIG. 7 is a circuit diagram illustrating a demodulator.

FIG. 8 is a circuit diagram illustrating further details of the demodulator illustrated in FIG. 7.

FIG. 9 illustrates a method of controlling an antenna.

FIG. 10 is a block diagram illustrating a surveillance video camera configured to receive DC power and control commands over the same connectors used to output video information.

### DETAILED DESCRIPTION

Embodiments of the presently disclosed invention provide for communication of multiple, optionally independent, signals over the same conductors in some instances this communication allows the use of a fewer number of conductors in a particular application. For example, an RF signal configured for broadcast by an antenna may be communicated to the antenna over the same connectors as data configured for configuring or otherwise controlling the antenna. The multiple signals may be communicated at different frequencies such that they may be separated and independently processed after being received. The multiple signals may be sent in the same or different directions over the conductors and may be added or received from the conductors at different locations. The multiple signals may further be communicated serially or in parallel.

Embodiments of the presently disclosed invention may include an antenna controller and a configurable antenna that has been configured as a wireless access point (e.g., WiFi). In such embodiments, an RF signal may be communicated from the antenna controller to the configurable antenna for the purpose of being broadcast by the configurable antenna. Digital data for configuring the antenna may be communicated from the antenna controller to the configurable antenna over the same electrical conductors. This digital data may be communicated for the purpose of steering the configurable antenna.

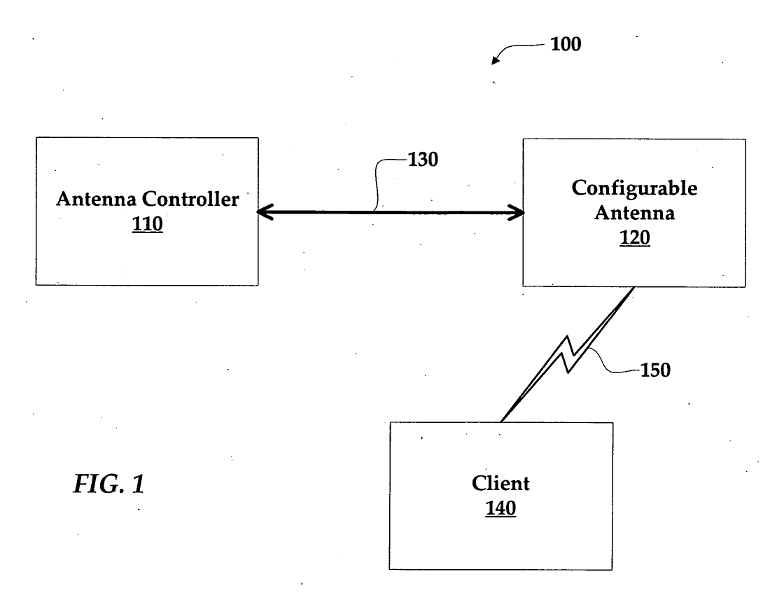

FIG. 1 is a block diagram illustrating a Wireless Communication System 100 and including an Antenna Controller 110, a Connector 130, and a Configurable Antenna 120. Antenna Controller 110 may be configured to generate an RF signal to be transmitted using Configurable Antenna 120 to one or more Clients 140.

The Client 140 may include, for example, a radio modulator/demodulator. The Client 140 may also include a transmitter and/or receiver such as an 802.11 access point, an 802.11 receiver, a set-top box, a laptop computer, an IP-enabled television, a PCMCIA card, a remote control, a Voice Over Internet telephone or a remote terminal such as a handheld gaming device. In some embodiments, the Client 140 may include circuitry for receiving data packets of video from a router and circuitry for converting the data packets into 802.11 compliant RF signals as are known in the art. The Client 140 may include an access point for communicating to one or more remote receiving nodes (not shown) over a wireless link, for example in an 802.11 wireless network. The Client 140 may also form a part of a wireless local area network by enabling communications among several remote receiving nodes.

The RF signal generated by Antenna Controller 110 may include digitally encoded information intended for a receiver of the transmission. For example, the RF signal may include digitally encoded information according to the IEEE 802.11x standards. Antenna Controller 110 may be further configured to generate an antenna control signal for controlling operation of Configurable Antenna 120. This antenna control signal may include antenna control data that is, for example, configured to select specific RF elements within Configurable Antenna 120, or to physically move Configurable Antenna 120.

Antenna Controller 110 may include one or more integrated circuits configured to generate digital data in an RF signal for communication to a specific instance of Client 140. This specific instance of Client 140 may be associated with a particular configuration of Configurable Antenna 120. Configurable Antenna 120 may include a plurality of selectable RF elements, some of which may be activated in order to send an RF signal in the direction of the specific instance of Client 140. When Configurable Antenna 120 is used to communicate with a plurality of Client 140, this communication may include alternatively sending different data packets to different members of the plurality of Client 140. Because these different members of the plurality of Client 140 may be in different direction, Configurable Antenna 120 may be reconfigured between data packets. Using various embodiment of the presently disclosed invention, reconfiguration may be accomplished within a time interval as may otherwise be required by particular portions of the IEEE 802.11x standards.

Connector 130 includes electrical conductors (e.g., wires) configured to convey an RF signal and a separate antenna control signal. Connector 130 may optionally include DC power for operating logic within Configurable Antenna 120. The RF signal, the separate antenna control signal, and the DC power may be conveyed over the same shared electrical connectors. Connector 130 may include only two wires (e.g., a power/signal wire and a neutral wire). In an alternate embodiment, Connector 130 may include more than two wires, at least one of which is used for communicating the RF signal, the separate antenna control signal, and DC power. Connector 130 may optionally be configured to connect to Antenna Controller 110 using a SubMiniature version A (SMA) connector.

Configurable Antenna 120 may be configured to communicate with one or more instances of Client 140 via a Wireless RF Signal 150. Configurable Antenna 120 includes selectable antenna elements such as those described in U.S. patent application Ser. No. 11/414,117 filed Apr. 28, 2006 and entitled “MultiBand Omnidirectional Planar Antenna Apparatus With Selectable Elements” and/or U.S. patent application Ser. No. 11,413,461 filed Apr. 28, 2006 and entitled “Coverage Antenna Apparatus with Selectable Horizontal and Vertical Polarization Elements.”

Selectable elements of Configurable Antenna 120 may be selected in order to optimize communication with a specific instance of Client 140. Thus, different elements may be selected to communicate with different instances of Client 140. The selection of particular antenna elements may be achieved using various aspects of antenna control as disclosed in the present invention. For the purposes of illustration herein, Configurable Antenna 120 includes six configurable elements that may be selected in various combinations. In alternative embodiments, Configurable Antenna 120 may include more or fewer configurable antenna elements.

The RF signal communicated through Connector 130 may be in the gigahertz frequency range; for example, near 2.4 or 5.8 GHz. In contrast, the antenna control signal is typically in a lower or higher frequency range. For example, the antenna control signal may be in the megahertz, kilohertz, or hertz ranges. The antenna control signal may be configured such that it lacks harmonics at the RF signal frequency. In some embodiments, the antenna control signal may be related to a clock frequency of a logic circuit within Antenna Controller 110. For example, if Antenna Controller 110 includes a processor running at 33 MHz, the antenna control signal may be operated at 33 MHz or a sub-harmonic thereof.

The antenna control signal may be communicated by modulating the voltage of a DC source configured to power logic circuits within Configurable Antenna 120. For example, if logic circuits within Configurable Antenna 120 are configured to operate with a 1.8 volt supply, the DC source may be modulated between essentially 0V and 1.8V. In some embodiments, the DC source may be modulated between 0V and a voltage greater than that normally required by logic circuits within Configurable Antenna 120. For example, if the logic circuits require 1.8V, the DC source may be modulated between 0V and 3.3V. The over voltage of 1.5V (3.3V−1.8V) may be dropped through one or more isolation diodes and stepped down using a voltage regulator.

The antenna control signal may be communicate by varying the magnitude of DC modulation, the frequency of DC modulation, and/or the length of periods during which the DC is HIGH or LOW. For example, the length of time in which the DC source is held low may be used to convey the “1s” and “0s” of digital data. If the DC source is held low for a short period of time (e.g., one or two clock cycles) a 0 is communicated. If the DC source is held low for a longer period of time (e.g., three or more clock cycles at 1 is communicated. Digitization of the short and longer periods may be accomplished by sampling the changing or discharging of a capacitor.

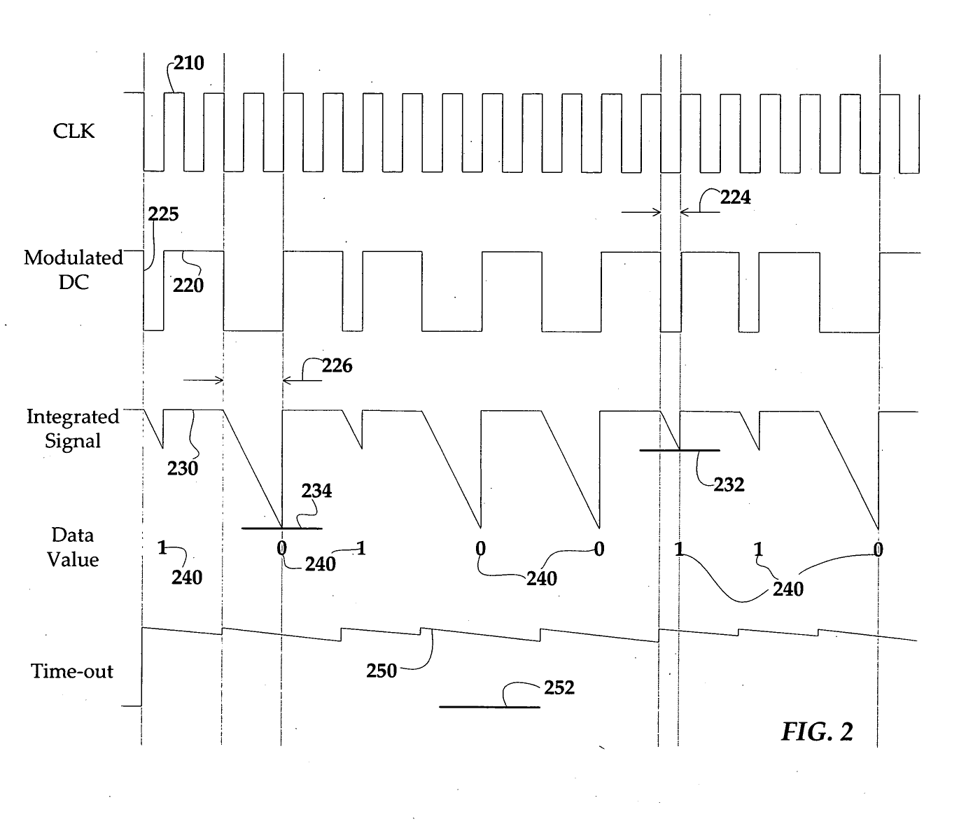

FIG. 2 is a timing diagram illustrating the communication of digital data using a modulated DC signal. In FIG. 2, 0s are communicated by hold a DC source low for one clock cycle. 1s are communicated, in FIG. 2, by holding a DC source low for two clock cycles. Alternative encodings are within the scope of the presently disclosed invention. For example, 0s may be communicated by holding the DC source for five clock cycles while 1s are communicated by holding the DC source down for 11 clock cycles. Thus, eight 0s may be communicated in 5×8 clock cycles, or 5×8×30 ns=1.2 microseconds for a 33 MHz clock. Likewise, eight 1s may be communicated in 11×8 clock cycles, or 11×8×30 ns=2.7 microsecond for a 33 MHz clock. With this clock, other bit patterns may take between 1.2 and 2.7 microseconds.

A First Trace 210 of FIG. 2 represents a clock signal, abbreviated CLK. This clock signal may be a clock signal used for performing logic within Antenna Controller 110, or sub-harmonic thereof. Alternatively, this clock signal may be derived from a separate crystal oscillator. This clock signal need not be synchronized with Configurable Antenna 120.

A Second Trace 220 of FIG. 2 represents a modulated DC signal. This signal may be used to convey both antenna control signals and to power logic circuits within Configurable Antenna 120. The communication of antenna control signals may be initiated by a Falling Edge 225 in the DC potential. In such an instance, a first falling edge after a significant delay may be considered the start of antenna control data. Alternatively, a specific data header encoded in the modulated DC may be used to indicate the start of antenna control data. In the embodiments illustrated in FIG. 2, a Period 224 of ½ clock cycle is used to convey a 1 and a Period 226 of 3/2 clock cycle is used to convey a 0.

A third Trace 230 of FIG. 2 represents an integrated signal as may be generated at Configurable Antenna 120 by a demodulator. The integrated signal may be generated by charging (LOW to HI) a capacitor or discharging (HI to LOW as shown in FIG. 2) a capacitor. A digital value representative of the antenna control data is produced by sampling the integrated signal when the modulated DC returns to a high level (e.g., at the end of Periods 224 or 226). Continuing with the aforementioned example, at the end of Period 224 Voltage Level 232 is measured. Voltage Level 232, in the present example, is representative of a 1. Likewise, at the end of Period 226 Voltage Level 234 is measured. Voltage Level 234 is, in the context of FIG. 2, representative of a 0. These representations are illustrated by the 1s and 0s Values 240 shown throughout FIG. 2.

A Fourth Trace 250 of FIG. 2 represents an optional time-out signal. In various embodiments, this time-out signal may be used to prevent system lockups that could result from missed modulated data. The time-out signal may further be used to help identify the start of antenna control data. For example, the time-out signal may be reset each time a falling edge, such as Falling Edge 225, is detected in the modulated DC. Between these falling edges, the time-out signal is allowed to discharge. If the time-out signal reaches a predetermined voltage level, such as Voltage Level 252, then logic within Configurable Antenna 120 will operate on the assumption that no antenna control data is being communicated. If the last set of antenna control data received was incomplete, that data will be discarded. This process prevents the logic within Configurable Antenna 120 from becoming locked in a state where it is expecting more data.

In some embodiments, the time-out signal is configured to reach Voltage Level 252 between sets of antenna control data. In such an embodiment, when a new set of antenna control data is communicated, Falling Edge 225 may be identified because it occurs when the time-out signal is low. This may allow logic within Configurable Antenna 120 to identify the start of a new set of antenna control data. In various embodiments, the antenna control data may include 1, 2, 4, 6, 8 or more bits.

While “1s” (in FIG. 2) are encoded by a low signal for ½ clock cycle and “0s” are encoded by a low signal for 3/2 clock cycle, alternative embodiments may include encoding data using an integer number of clock cycles. In such embodiments, the encoding may be responsive to rising (or alternatively falling) clock edges. For example a “1” may be encoded by a low signal for one clock cycle and a “0” may be encoded by a low signal for two or more clock cycles, or vice versa.

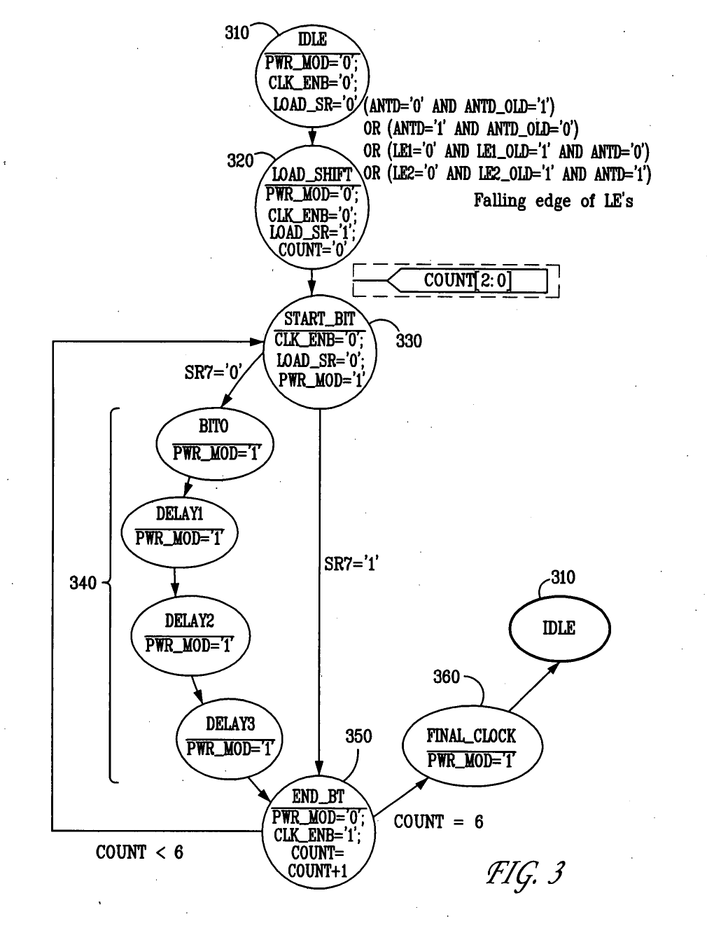

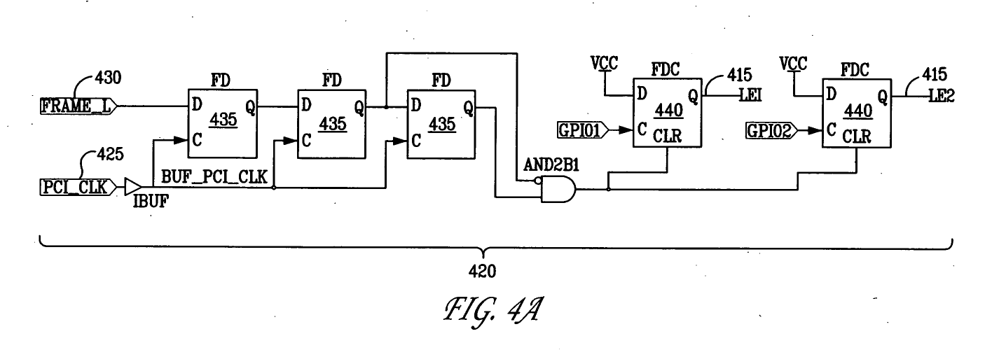

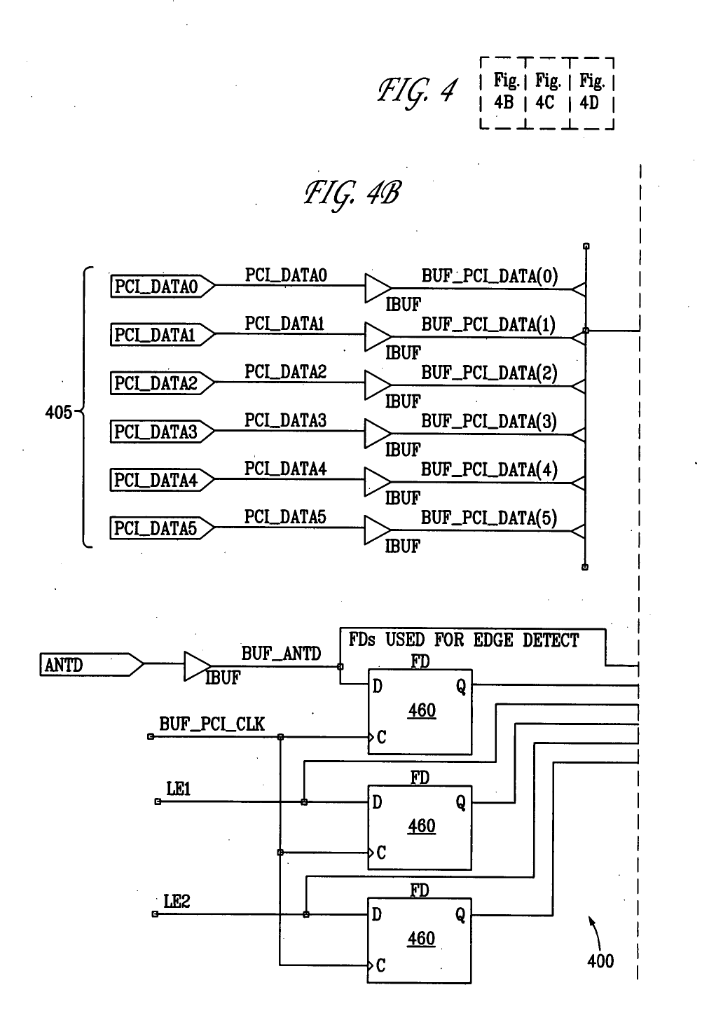

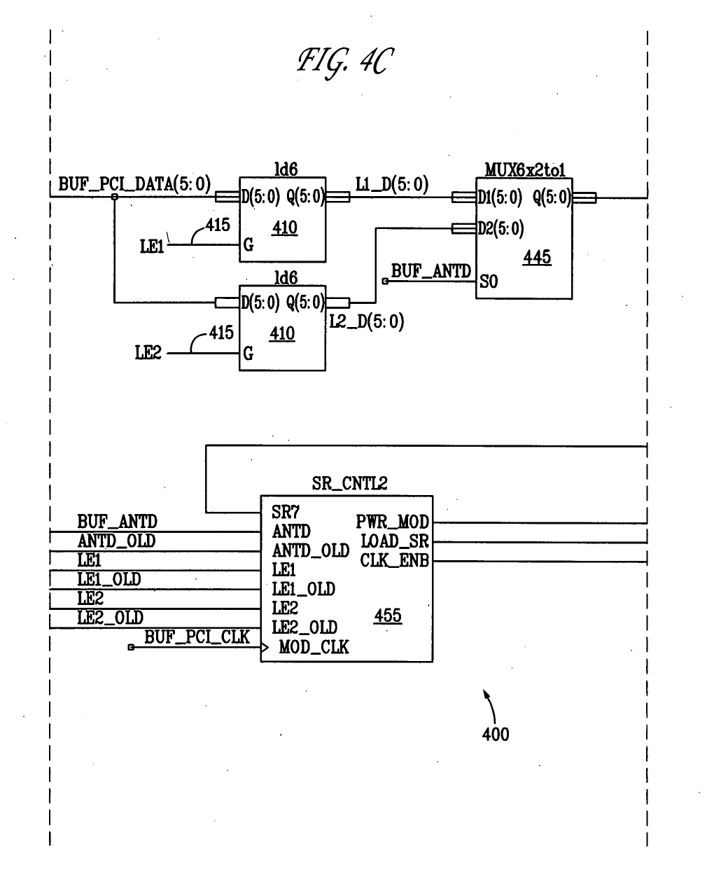

FIG. 3 is a flow diagram illustrating the operation of a state machine. This state machine may be programmed into logic devices within Antenna Controller 110 to encode a modulated DC signal. A similar state machine may be programmed into logic devices within Configurable Antenna 120 to decode a modulated DC signal.

In a First State 310, the state machine is idle and the various control variables are 0 as shown. In Load State 320 a desired configuration of Configuration Antenna 120 is loaded into a shift register (LOAD-SR=‘1’). In a Third State 330 a loop is started in encode each bit of antenna control data representative of the desired configuration into the modulated DC. This loop is repeated for each bit. In the embodiment illustrated in FIG. 3, 6 bits are encoded as tracked by the state variable “COUNT.”

If the bit to be encoded within the loop is a 0 (SR7=‘0’), then the state machine progresses through a series of Delay States 340. During these delays, the value of a PWR_MOD state variable is held high. The value of this state variable and the delays result in the modulated DC signal being held low for Period 226 (FIG. 2). After Delay States 340, in an Fourth State 350, the PWR_MOD variable is given a 0 value and the COUNT variable is incremented. If COUNT is less than 6 then there are further bits to encode and the state machine returns to the Third State 330. If count is equal to 6 then all of the bits have been encoded and the state machine proceeds to a Final State 360, where the PWR_MOD state variable is once again held high, and then back to First State 310. If the bit to be encoded within the loop is a 1 (SR7=‘1’), then Delay States 340 are skipped and the modulated DC signal is held low for a Period 224 (FIG. 2). The transition to Final State 360 is optionally used to clock data between circuits within Configurable Antenna 120 (e.g., from a shift register to a latch).

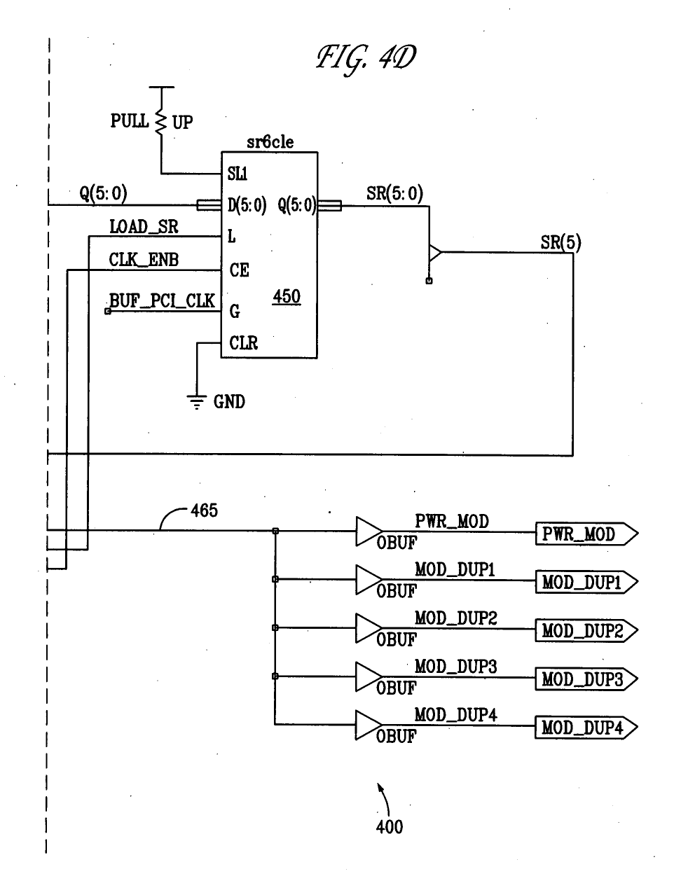

FIG. 4 is a circuit diagram illustrating an Electronic Circuit 400 as may be included in Antenna Controller 110. Electronic Circuit 400 may be configured implemented where the antenna control data to be conveyed to Configurable Antenna 120 is received from a PCI bus. The communication of antenna control data from Antenna Controller 110 to Configurable Antenna 120 is responsive to and synchronized with the RF signals to be broadcast from Configurable Antenna 120. If the RF signals to be broadcast from Configurable Antenna 120 include data packets intended for different instances of Client 140, then Configurable Antenna 120 may need to be reconfigured between transmissions of these data packets.

Electronic Circuit 400 as illustrated in FIG. 4 includes a series of Data inputs 405 configured to receive 6 bits of antenna control data to control 6 different antenna elements from a PCI bus. These data may be stored in one of two alternative Data Latches 410. Data Latches 410 may be configured such that one set of antenna control data can be ready while the next set is loading, which may be of use when timelines of the antenna control data is an issue.

Data Latches 410 may alternatively be achieved by a pair of Inputs 415 (LE1 and LE2). Signals to LE1 and LE2 may be generated by a PCI Bus Decoder 420 configured to receive a PCI_CLK 425 and a Start of Frame Signal 430. PCI Bus Decoder 420, as illustrated in FIG. 4, includes a series of Flip-Flops 435 configured to generate a proper wait state, and a pair of Flip-Flops 440 that are controlled by general processor logic outputs GPI01 and GPI02.

The outputs of Data Latches 410 may alternatively be received by a MUX 445. MUX 445 is under the control of a real-time hardware signal BUF_ANTD that allows precise control of communication of antenna control data.

The output of MUX 445 is received by a Shift Register 450 configured to convert the parallel set of bits received from Data Inputs 405 into a serial signal

The output of Shift Register 450 is communicated to a State Machine (shift register controller state machine) 455 configured to operate as illustrated and described in the context of FIG. 3. State Machine 455 receives gate control logic (e.g., BIF_ANTD, LE1 and LE2) through a set of Flip-Flops 460 such that State Machine 455 knows when to start modulating data. State Machine 455 may also be programmed to perform the state machine operations illustrated in FIG. 3. An output of State Machine 455 may include PWR_MOD Signal 465, which includes the encoded antenna control signal as determined by the state variable PWR_MOD of FIG. 3.

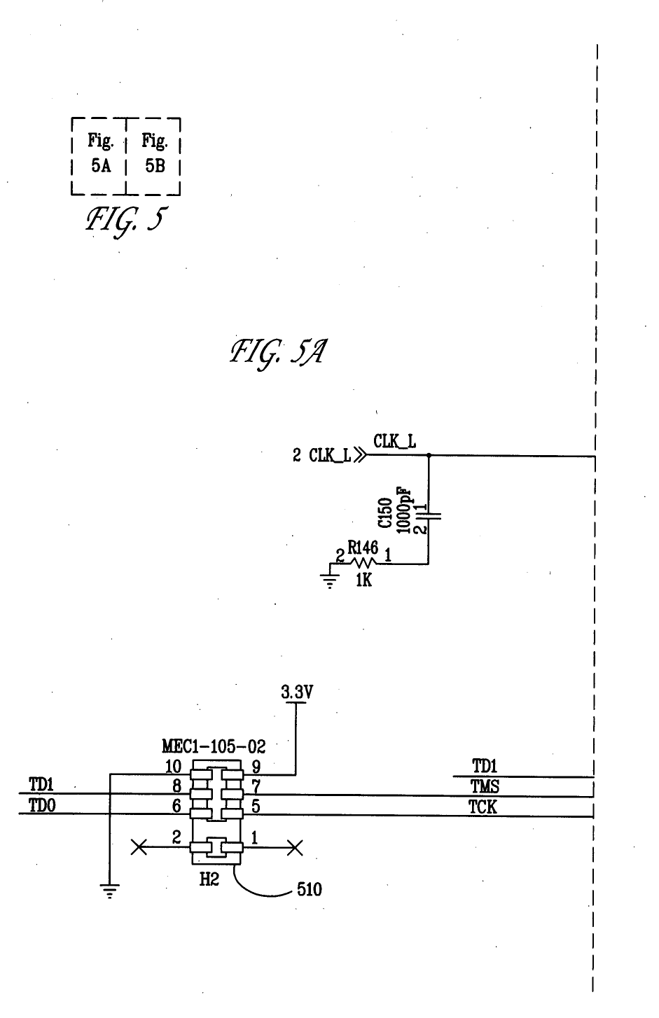

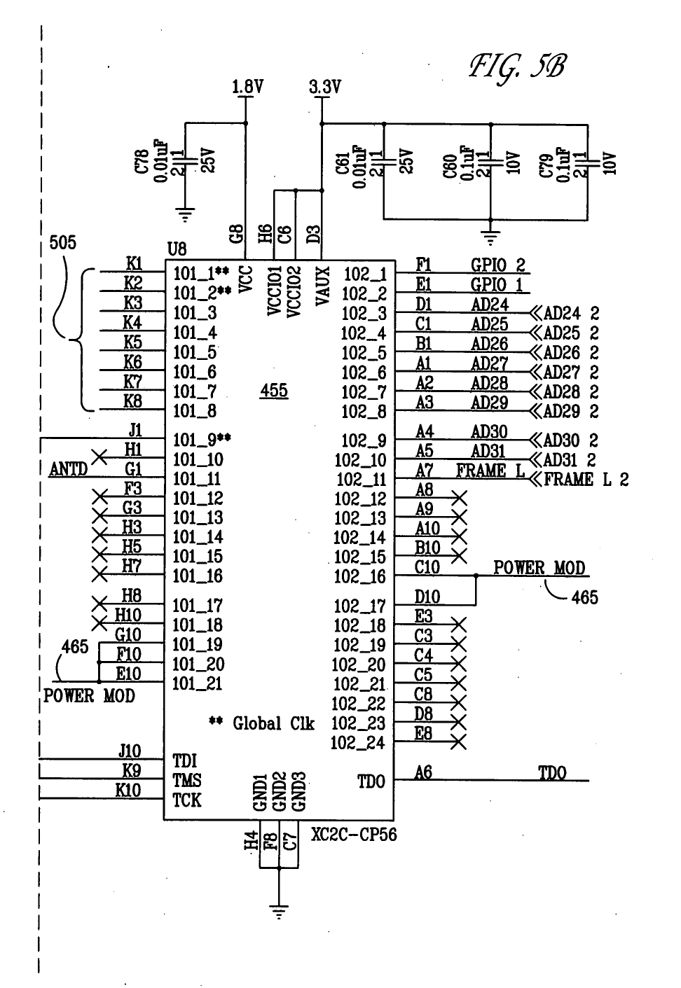

FIG. 5 is a circuit diagram illustrating further details of a State Machine 455. Inputs 505 (IO1_1-IO1_8) may optionally be coupled to external connectors for the purposes of programming and debugging. Likewise, Inputs TD1, TMS and TCK may be connected to External Connectors 510 for serial programming and/or debugging. External Connectors 510 may include an edge connector. More than one output of CPLD may be used to generate the PWR_MOD Signal 465 (POWER_MOD in FIG. 5). In FIG. 5, outputs IO1_19, IO1_20, IO1-21, IO2_16 and IO2_17 are combined and used to generate the PWR_MOD signal. The use of several outputs may provide additional drive current for DC modulation.

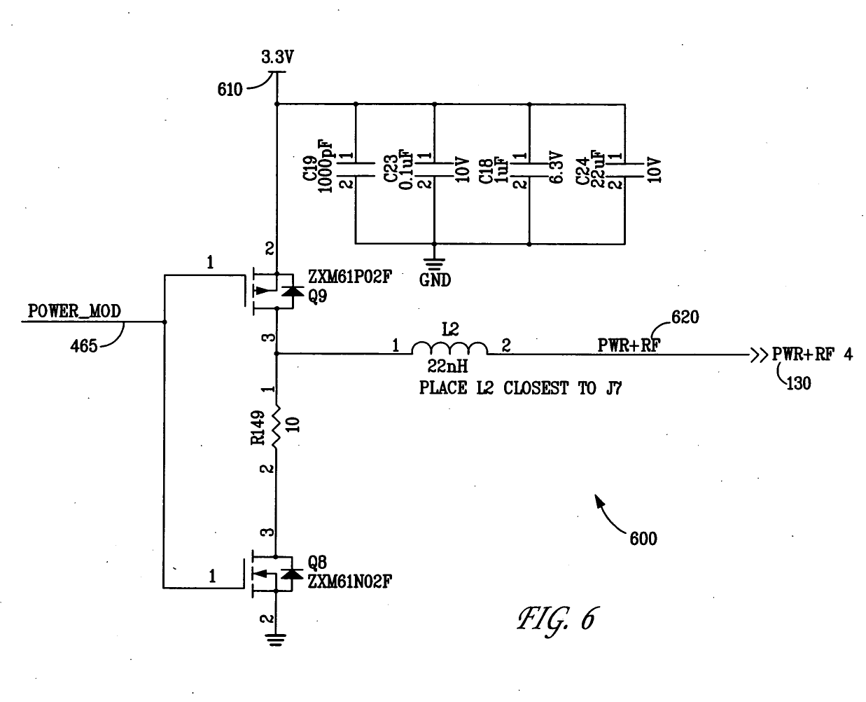

FIG. 6 is a circuit diagram illustrating an Output Circuit 600 of a digitally controllable DC modulator as may be included in Antenna Controller 110. Output Circuit 600 may be configured to use the POWER_MOD Signal 465 to modulate a DC Potential 610, and to combine the modulated DC potential with an RF signal 620. The resulting signal is conveyed through Connector 130 to Configurable Antenna 120.

Output Circuit 600 provides DC power of, for example, 3.3 volts for powering circuits within Configurable Antenna 120, a modulation of the DC power responsive to POWER_MOD Signal 465 and encoded with antenna control data, and an RF signal to be broadcast by Configurable Antenna 120 to one or more Clients 140. The RF signal to be broadcast is optionally encoded with digital data for use by Client 140.

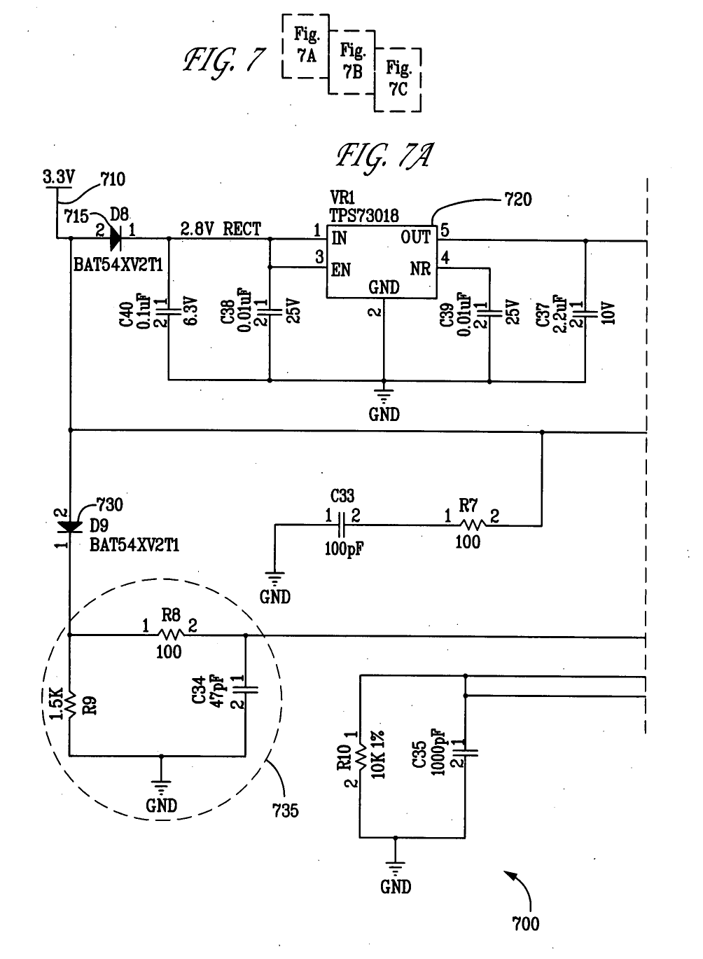

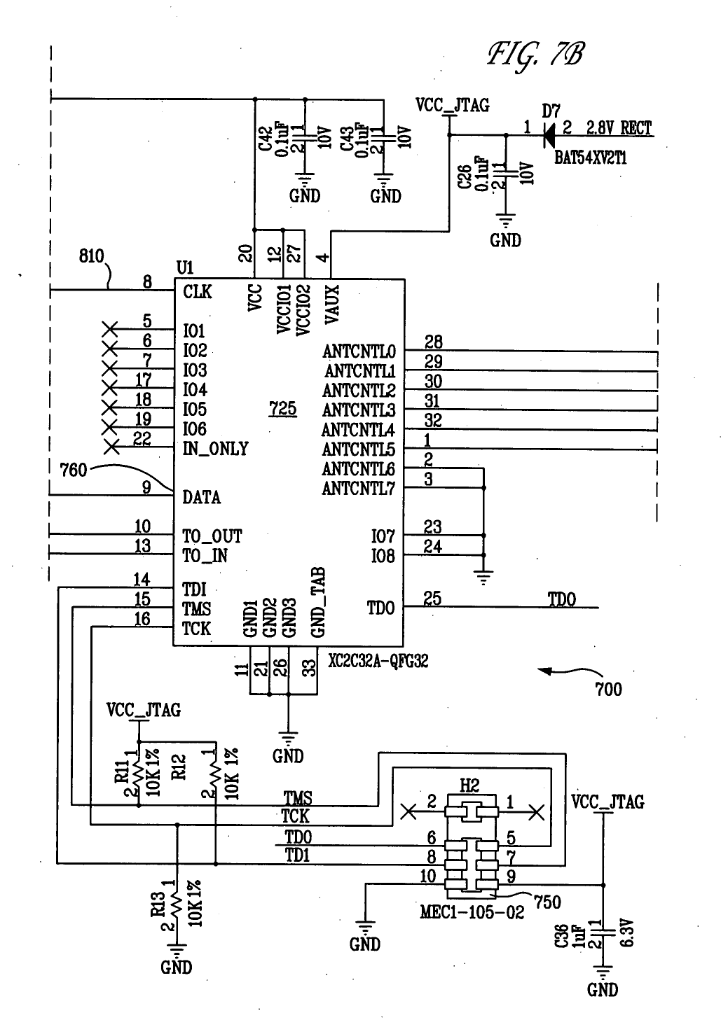

FIG. 7 is a circuit diagram illustrating a Demodulator 700 as may be found in Configurable Antenna 120. Demodulator 700 may be configured to receive an input from Antenna Controller 110 via Connector 130 at Input Point 703. Part of the received input may be passed through Inductor 705, which serves to separate the (modulated) DC component of approximately 3.3V from the RF signal received through Connector 130. A first part of the DC component may be passed through Point 710 to Diode 715. Diode 715 may result in a 0.5 Volt reduction in the DC potential of the signal from 3.3V to approximately 2.8V. The 2.8V DC potential may be provided to DC Regulator 720, which may be designed to generate a well conditioned 1.8V output to be provided to the VCC (power) input of a CPLD 725. A second part of DC component may be passed through Diode 730, through an RC (frequency dependent) Filter 735, and provided to CPLD 725 as serial input data at Data Input 760. This serial input data is asynchronous and is represented by Third Trace 230 of FIG. 2. Filter 735 serves to distinguish “0s” and “1s” in the serial input data. If the DC signal is held low for long enough, then a 0 will be sensed at Data Input 760, otherwise a 1 will be sensed.

An RC Circuit 738 is configured to generate the time out signal illustrated by Fourth Trace 250 of FIG. 2. The slope of Fourth Trace 250 may be determined by the discharge of the capacitor labeled C35 through the resister labeled R10. As is illustrated in FIG. 2, the capacitor C35 is recharged responsive to detection of a modulated DC signal. If capacitor is allowed to discharge to a predetermined level then a timeout will occur.

CPLD 725 is configured to use the received serial input data to control (e.g., select or turn on and off) a plurality of Antenna Segments 740A-740F. CPLD 725 may be configured to produce outputs at ANTCNTL0-ANTCNTL5 that are otherwise configured to control the bias of Diodes 755A-755F. In one bias state, Diodes 755A-755F will convey the RF component of the signal received at Input Point 703 to Antenna Segments 740A-740F, respectively. In another bias state, Diodes 755A-755F will prevent the receive RF component of the signal from reaching Antenna Segments 740A-740F. Thus, by individually controlling the bias of Diodes 755A-755F, Antenna Segments 740A-740F may be individually controlled. Diodes 755A-755F are, in some embodiments, PIN diodes.

CPLD 725 optionally includes an External Interface 750 configured for programming and/or debugging CPLD 725. External Interface 750 is, in some embodiments, an edge connector.

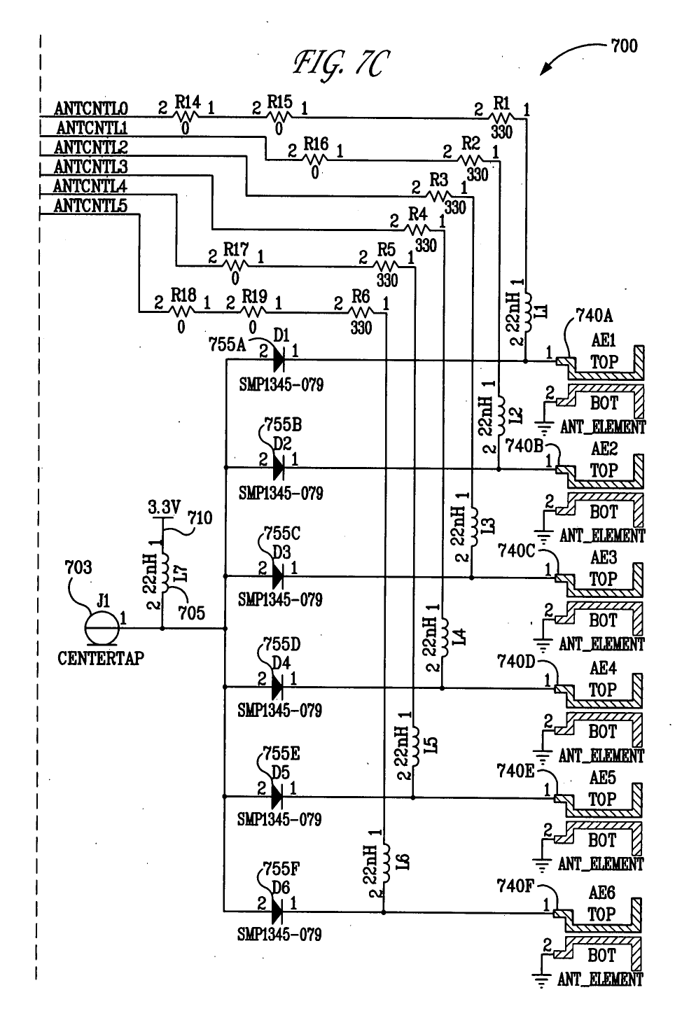

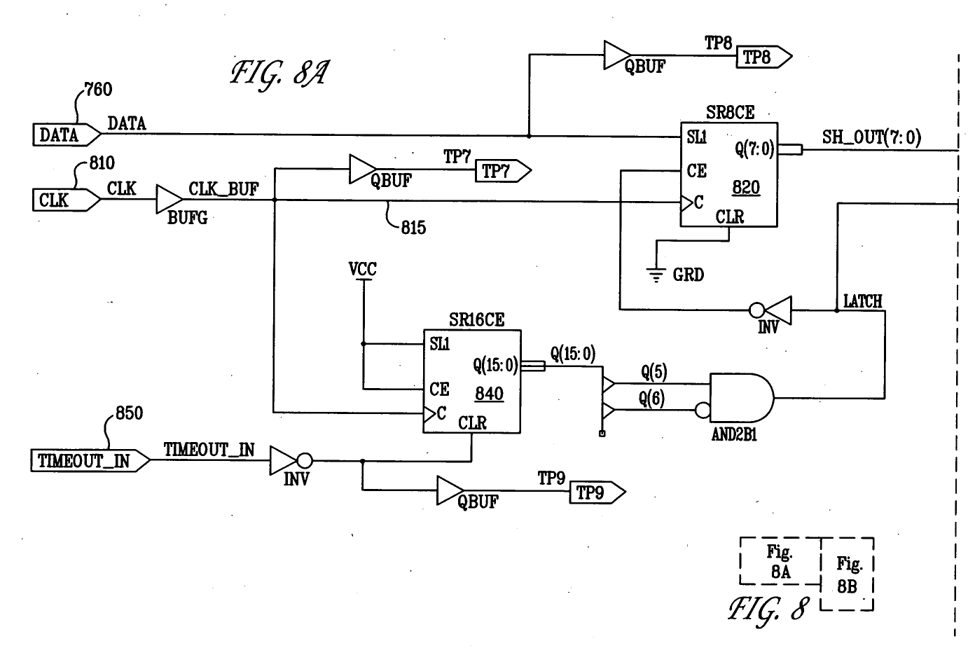

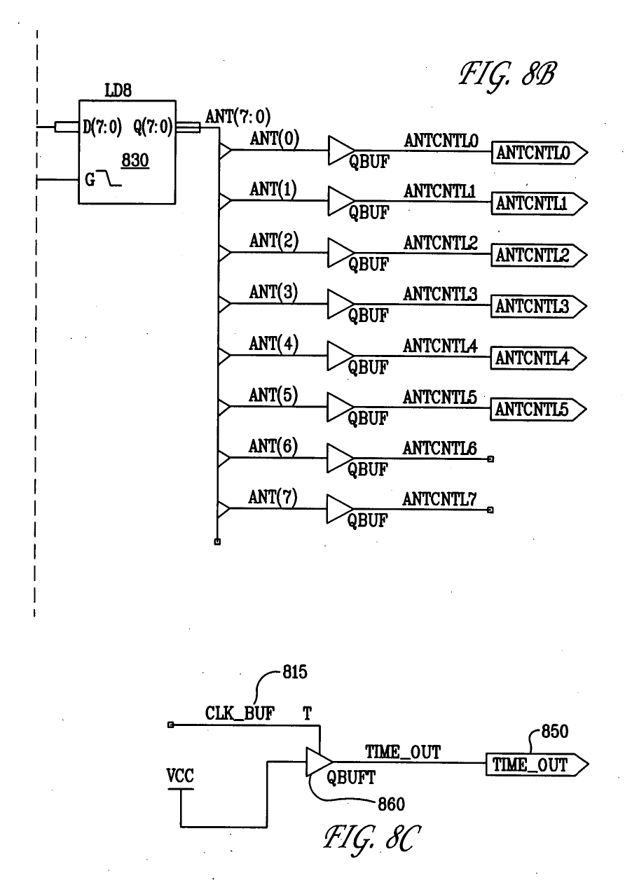

FIG. 8 is a circuit diagram illustrating further details of CPLD 725. CPLD 725 receives (asynchronous) serial input data at Data Input 760, and a CLK (clock) Input 810. Under the control of CLK Input 810, the data is received by a Shift Register 820. Shift Register 820 is configured to generate a parallel output from the asynchronous serial data received. The synchronous serial output is provided to a Latch 830, which at the appropriate time is configured to provide output at ANTCNTL0-ANTCNTL5 of CPLD 725. These outputs may be used for controlling Antenna Segments 740A-740F, respectively.

The operation of Shift Register 620 is subjected to a Shift Register 840 configured to count edges (data bits) received and may be cleared by a Time-out Signal 850. As long as the 7^{th} bit occurs before the timeout signal reaches a low state. Shift Register 840 triggers Latch 830 to latch data from Shift Register 820 on the 7^{th} bit. Time-out Signal 850 is generated by providing a CLK_BUF Input 815 to a Tri-state Buffer 860.

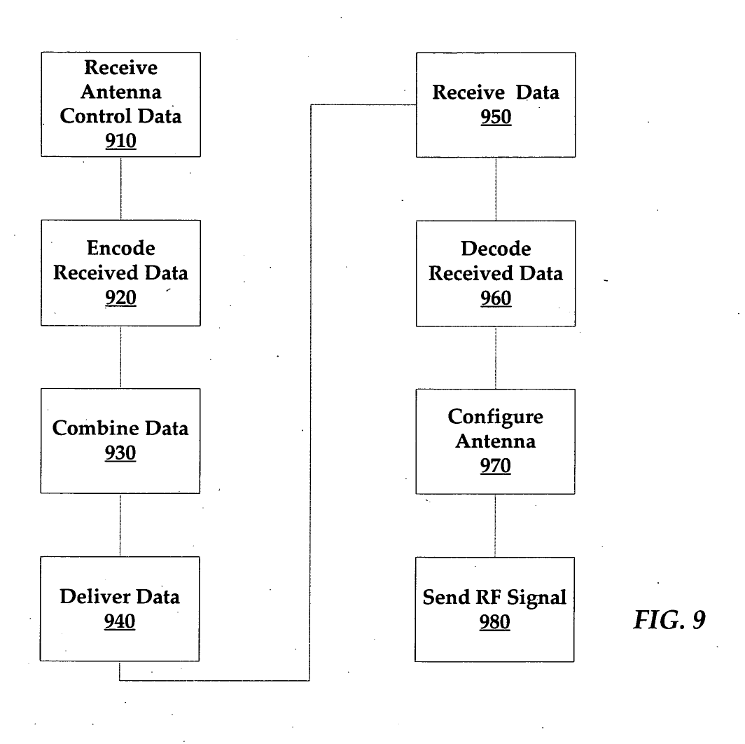

FIG. 9 illustrates a method of controlling an antenna. In Receive Antenna Control Data Step 910, a circuit within Antenna Controller 110 receives digital information regarding a preferred antenna configuration. The information may be received over a bus such as a PCI bus and may concern which antenna elements should be selected (turned on or off) for sending a particular wireless data packet. In some embodiments, the receipt of the information is synchronized with availability of the particular wireless data packet.

In Encode Received Data Step 920, the received information is encoded into a modulated DC signal, such as that illustrated by Second Trace 220 of FIG. 2. The DC signal is configured to both convey the received information and to power logic circuits within Configurable Antenna 120.

In optional Combine Data Step 930, the modulated DC signal is combined with an RF signal configured to be transmitted (e.g., broadcast) by Configurable Antenna 120 into a signal stream. This combination is typically serial, e.g., RF signal data packets are separated by antenna configuration data.

In Deliver Data Step 940, the signals combined in Combine Data Step 930 are delivered from Antenna Controller 110 to Configurable Antenna 120 via Connector 130. The combined signals may be sent over the same electrical conductors. For example, data for configuring Configurable Antenna 120 to transmit an RF signal to a specific instance of Client 140 may be sent prior to the RF signal intended for the specific instance of Client 140.

In Receive Data Step 950, the combined signals are received by Configurable Antenna 120. In Decode Received Data Step 960, antenna control data is decoded from the modulated DC signal. In Configure Antenna Step 970, the decoded antenna control data is used to configure Configurable Antenna 120. In Send RF Signal Step 980, the RF signal is sent to Client 140 using the configured Configurable Antenna 120.

In some embodiments of the method illustrated in FIG. 9, the number of antenna control bits included in the antenna control data is fewer than the number of antenna elements controlled. In these embodiments, only selected combinations of antenna elements may be selected.

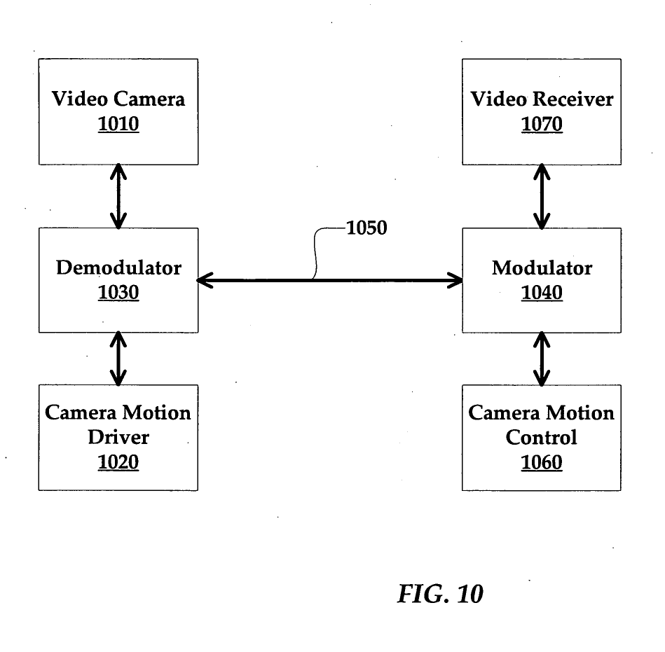

FIG. 10 is a block diagram illustrating an alternative embodiment of the presently disclosed invention. In the present embodiment, surveillance video cameras are configured to receive DC power and control commands over the same connectors that they output video information.

Video Camera 1010, in FIG. 10, is controlled by a Camera Motion Driver 1020. The Video Camera 1010 is configured to send an RF signal to a Video Receiver 1070 and, optionally, to receive DC power from Video Receiver 1070. Camera Motion Driver 1020 is configured to be controlled by a Camera Motion Control 1060.

A connector 1050 is configured to convey control signals from Camera Motion Control 1060 to Camera Motion Driver 1020. Connector 1050 may also be configured to convey RF signals from Video Camera 1010 to Video Receiver 1070. Both of these signals may be conveyed over the same electrical conductors. Thus, Connector 1050 may include as few as two electrical conductors (signal and neutral).

Control signals from Motion Control 1060 may be conveyed at different frequencies than RF signals from Video Camera 1010. For example, in one embodiment, the control signals are encoded on a modulated DC signal that is also used to power Video Camera 1010 and/or Camera Motion Driver 1020. This modulation is performed by a Modulator 1040 using techniques discussed herein. After conveyance via Connector 1050, the control signals are demodulated using a Demodulator 1030. Demodulator 1030 may be configured to use demodulation techniques as discussed herein. The demodulated signals are provided to Camera Motion Driver 1020.

Because signals between Camera Motion Control 1060 and Camera Motion Driver 1020 are conveyed over the same electrical conductors as the RF signal, Camera Motion Control 1060 and Camera Motion Driver 1020 may be added to a pre-existing video system without adding electrical connectors to Connector 1050.

Several embodiments are specifically illustrated and/or described herein. It will be appreciated that modifications and variations are covered by the above teachings and within the scope of the appended claims without departing from the spirit and intended scope thereof. For example, in some embodiments the antenna control signal is in a higher frequency range than the RF signal. For example, the DC signal may also be used to power a power amplifier and/or a low noise RF amplifier within Configurable Antenna 120.

The disclosed embodiments are illustrative. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system comprising:
a circuit configured to receive an antenna configuration for defining a state of a configurable antenna;
A circuit configured to receive a radio frequency signal to be sent by the configurable antenna in the state;
a circuit configured to provide a DC potential to the configurable antenna, the DC potential being sufficient to power an integrated circuit within the configurable antenna;
a circuit configured to modulate the DC potential to encode the antenna configuration in a modulated DC potential; and
an output configured to convey both the modulated DC potential and the radio frequency signal to the configurable antenna through a shared conductor.
